(19) United States
(12) Patent Application Publication
(10) Pub. No.: US 2008/0092976 A1
(43) Pub. Date: Apr. 24, 2008

(54) Blower duct

(75) Inventors: Satoshi Nakazawa, Kawagoe-shi (JP); Maki Yamazaki, Kawagoe-shi (JP); Takeshi Saito, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KOMATSU ZENOAH CO., Kawagoe-shi (JP)

(21) Appl. No.: 11/584,023

(22) Filed: Oct. 20, 2006

(51) Int. Cl. F16L 9/00

(52) U.S. Cl. 138/177; 138/DIG. 11

(57) ABSTRACT

A portable-blower duct has a bendable portion (22) whose inner peripheral surface (221A) is a cylindrical surface without any protrusions or recesses in a normal state or in an expanded state, that is, unless it is greatly curved. With this construction, no turbulence is generated in air passing through a tube (221), thereby making it possible to suppress pressure loss. Thus, the flow velocity of air guided through the duct is not reduced, thereby suppressing a deterioration in air blowing efficiency. Even when the tube (221) is curved, the outer side of the curved portion is expanded, and the corresponding portion of the inner peripheral surface remains a smooth surface, thus making it possible to minimize the air pressure loss.

### BACKGROUND OF THE INVENTION

1. Field of the Invention

The present invention relates to a blower duct, in particular, a duct equipped with a bendable portion capable of changing a direction of air discharged from a blower.

2. Description of Related Art

Hitherto, there has been known a portable blower which performs cleaning by blowing away dust, fallen leaves, etc. with air sucked therein (see, for example, JP 2003-97493 A, FIGS. 1 through 3).

The blower disclosed in the above-mentioned publication is equipped with a blower main body and a duct mounted to a forward end portion of the blower main body. The duct is equipped with a bendable portion connected to the blower, a rotary portion connected to the bendable portion, a muffler connected to the rotary portion, and a nozzle connected to the muffler. The bendable portion is formed in a so-called bellows-like configuration, in which small diameter portions with a small inner diameter and large diameter portions with a large inner diameter are alternately connected together, and with this configuration, exhibits flexibility. In this portable blower, the air sent out from the blower main body passes through an elbow and the bendable portion to be blown out through the nozzle.

In the related art blower as disclosed in the above-mentioned publication, the bendable portion has on its outer surface and inner surface a plurality of protrusions and recesses formed between the small diameter portions and the large diameter portions. When there are protrusions and recesses on the inner surface of the bendable portion, turbulence is generated in the airflow from the blower, resulting in generation of air pressure loss. Thus, as a result of the pressure loss due to this air turbulence, the wind pressure becomes so much the lower, resulting in a deterioration in air blowing efficiency of the blower.

### SUMMARY OF THE INVENTION

It is a principal object of the invention to provide a blower duct helping to achieve an improvement in air blowing efficiency.

A blower duct according to an aspect of the invention includes: a bendable portion composed of a tube, whose inner peripheral surface is a smooth surface at least in a non-contracted state, and which exhibits flexibility; and protruding portion, which are each formed substantially in an annular configuration extending in a circumferential direction of the tube, and are arranged at predetermined intervals in an axial direction of the tube.

According to the aspect of the invention, when the flexible tube is not greatly contracted, that is, when it is in a normal state in which no external force is being applied thereto, or when, even if an external force is applied thereto, it is expanded due to that external force, the inner peripheral surface of the flexible tube is a smooth surface, so no turbulence is generated in the air passing through the tube, and pressure loss is prevented. In a state in which the tube is curved, contraction occurs on the inner side of the curved portion of the tube, and the inner peripheral surface of the contracted portion exhibits protrusions and recesses. However, on the outer side of the curved portion, the tube is expanded, and the inner peripheral surface of this expanded portion reliably provides a smooth surface, so it is possible to reduce the pressure loss.

### BRIEF DESCRIPTION OF THE DRAWINGS

FIG. 1 is a general schematic view of a portable blower according to an exemplary embodiment of the invention; and

FIG. 2 is a sectional view of a bendable portion of the exemplary embodiment taken along the axis thereof.

### DETAILED DESCRIPTION OF PREFERRED EMBODIMENT(S)

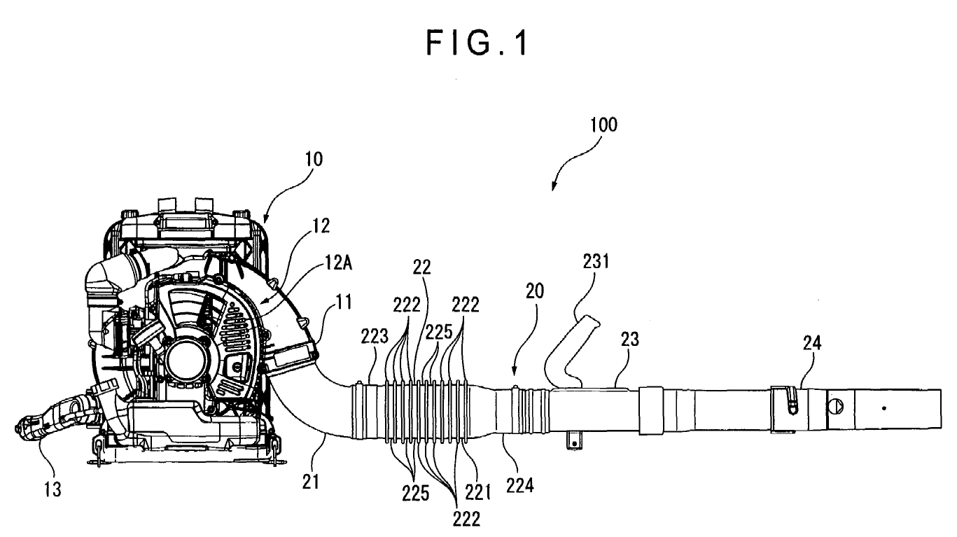

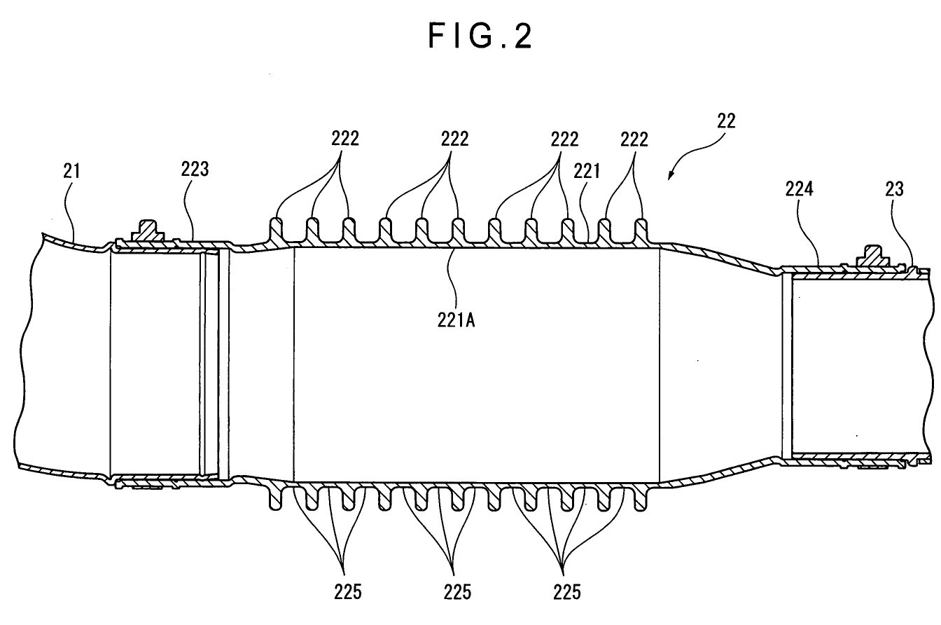

In the following, an exemplary embodiment of the invention will be described with reference to the drawings. FIG. 1 is a general plan view of a blower according to the exemplary embodiment. FIG. 2 is a sectional view of a part of the duct of the exemplary embodiment taken along the axis thereof.

### [Construction of the Portable Blower]

In FIG. 1, numeral 100 indicates a portable blower. The portable blower 100 is formed in a size and weight allowing the operator to carry it on operator's back, with operator's hand, etc. The portable blower 100 is equipped with a blower main body 10 and a duct 20 connected to the blower main body 10. Air sucked in by the blower main body 10 is supplied to the duct 20, and with the air blown out of the duct 20, it is possible to blow away dust, fallen leaves, etc.

The blower main body 10 is equipped with an air sending port 11 to which the duct 20 is connected, a volute 12 supplying air to the air sending port 11, and a throttle 13 for adjusting an amount of air supplied by the volute 12. The volute 12 has a rotary fan (not shown). This rotary fan receives a drive force transmitted from an engine (not shown) provided inside the blower main body 10, and rotates at a rotating speed according to an amount by which the throttle 13 is operated. Through the rotation of the rotary fan, outside air is sucked in through an intake port 12A, and is supplied to the air sending port 11. Instead of the engine provided inside the blower main body 10, it is also possible to provide an electric motor.

The duct 20 is equipped with an elbow 21 connected to the air sending port 11 of the blower main body 10, a bendable portion 22 connected to the elbow 21, an operation pipe 23 connected to the bendable portion 22, and an air outlet 24 connected to the operation pipe 23.

The elbow 21 is curved in a circular arc shape. The inner diameter of the elbow 21 is substantially the same as the inner diameter of the air sending port 11. With this construction, the air introduced from the air sending port 11 passes through the elbow 21 without involving any pressure loss, and is supplied to the bendable portion 22.

As shown in FIG. 2, the bendable portion 22 is equipped with a substantially cylindrical tube 221, a plurality of protruding portions 222 provided so as to extend in the circumferential direction of the tube 221, a blower connection portion 223 connected to the elbow 21, and an operation connection portion 224 connected to the operation pipe 23; the bendable portion 22 is formed of a flexible member made of a synthetic resin such as PP (polypropylene).

In the normal state in which the tube 221 is not greatly contracted, or if not in the normal state, in a state in which the tube 221 is expanded by an external force applied thereto, an inner peripheral surface 221A of the tube 221 is a smooth cylindrical surface without any protrusions or recesses. The protruding portions 222 provided on the outer peripheral surface of the tube 221 are formed integrally with the tube 221. The protruding portions 222, which protrude as continuous ring-like portions extending in a circumferential direction of the tube 221, are arranged at predetermined intervals in an axial direction of the tube 221. The portions between the protruding portions 222 are formed as groove portions 225 adapted to be recessed toward the axis when the tube 221 is contracted.

In the tube 221, constructed as described above, the groove portions 225 between the protruding portions 222 are deflected and recessed toward the axis of the tube 221, whereby the tube 221 as a whole can be contracted and curved, thereby generating protrusions and recesses on the inner peripheral surface 221A. However, when the tube 221 is in the normal state or in the expanded state, the inner peripheral surface 221A is a cylindrical surface without any protrusions or recesses, so no turbulence occurs, and no air pressure loss is generated. Even when the tube 221 is in the curved state, the groove portions 225 of the tube 221 are recessed toward the axis to generate protrusions and recesses in the portion of the inner peripheral surface 221A on the inner side (contracted side) of the curved portion. However, on the outer side (expanded side) of the curved portion, the groove portions 225 are not recessed, so the corresponding portion of the inner peripheral surface 221A is kept as a smooth surface, thus making it possible to minimize the air pressure loss.

The operation pipe 23 is connected to the bendable portion 22 and the air outlet 24, and causes the air from the bendable portion 22 to be blown out of the air outlet 24. Further, the operation pipe 23 is equipped with an operating grip 231. The operating grip 231 is a portion grasped by the operator when the portable blower 100 is to be operated; while grasping the operating grip 231, the operator directs the duct 20 in a desired direction in which air is to be blown out. It is also possible for the operating grip 231 to be equipped, for example, with an operation control lever for controlling the operation and stopping of the blower.

### [Effects of Exemplary Embodiment]

As described above, in the portable blower 100 of the exemplary embodiment, the inner peripheral surface 221A is a cylindrical surface without any protrusions or recesses when the tube 221 of the bendable portion 22 is in the normal state or in an expanded state. Thus, unless the tube 221 is greatly curved, no turbulence is generated in the airflow passing through the tube 221, thus making it possible to suppress pressure loss. Thus, the flow velocity of the air guided through the duct 20 is not lowered by pressure loss, thereby making it possible to suppress a deterioration in air blowing efficiency.

When the bendable portion 22 is curved, the inner peripheral surface 221A is contracted to generate protrusions and recesses on the inner side of the curved portion of the tube 221. In contrast, on the outer side of the curved portion of the tube 221, the inner peripheral surface 221A is expanded and reliably provides a smooth curved surface. Thus, even when the tube 221 is curved, due to the presence of the above-mentioned smooth surface, it is possible to reduce the air pressure loss as compared with that in the bendable portion of the related art blower duct, thus making it possible to achieve an improvement in air blowing efficiency.

### [Modifications of Exemplary Embodiment]

The invention is not restricted to the above-described exemplary embodiment but allows the following modifications as long as they help to achieve the object of the invention.

For example, while in the above-described exemplary embodiment a plurality of protruding portions 222 are provided as annular members extending along the outer peripheral surface of the tube 221 and arranged at predetermined intervals, this should not be construed restrictively. For example, the protruding portion may be one formed in a spiral configuration extending along the outer peripheral surface of the tube 221.

Further, while in the above-described exemplary embodiment the bendable portion 22 with a smooth inner peripheral surface is only provided between the elbow 21 and the operation pipe 23, this should not be construed restrictively. For example, it is also possible for the bendable portion 22 to be directly attached to the air sending port 11; it is also possible for the air outlet 24 to be directly attached to the bendable portion 22; further, it is also possible for the bendable portion 22 and the air outlet 24 to be formed integrally.

Apart from the above, the specific construction and procedures for carrying out the invention allow appropriate modifications as long as they help to achieve the object of the invention.

The basic application Number JP2005-255469 upon which this patent application is based is hereby incorporated by reference.

What is claimed is:

1. A blower duct, comprising:
a bendable portion composed of a tube, whose inner peripheral surface is a smooth surface at least in a non-contracted state, and which exhibits flexibility; and
a protruding portion, which is formed substantially in an annular configuration extending in a circumferential direction of the tube, and is arranged at predetermined intervals in an axial direction of the tube.

2. A blower duct according to claim 1, wherein:
the tube is a cylindrical member made of a synthetic resin; and
the protruding portion is formed integrally with the tube so as that the protruding portion is continuous with an outer peripheral surface of the tube.

3. A blower duct according to claim 1, wherein the protruding portion is formed in an annular configuration, and the plurality of the protruding portions are arranged at predetermined intervals.

4. A blower duct according to claim 1, wherein the protruding portion is formed in a spiral configuration on an outer peripheral surface of the tube, with adjacent portions thereof being arranged at predetermined intervals.
